(19) United States
(12) Patent Application Publication
(10) Pub. No.: US 2017/0362030 A1
(43) Pub. Date: Dec. 21, 2017

(54) ARTICULATED FRONT LOADER ARM MECHANISM FOR USE WITH A CONVENTIONAL REFUSE COLLECTION EXTENDED CAB CHASSIS

(71) Applicant: Wayne Industrial Holdings, LLC, Cedar Falls, IA (US)

(72) Inventor: David Alan Steimel, Waterloo, IA (US)

(73) Assignee: Wayne Industrial Holdings, LLC, Cedar Falls, IA (US)

(21) Appl. No.: 15/366,070

(22) Filed: Dec. 1, 2016

Related U.S. Application Data
(60) Provisional application No. 62/352,326, filed on Jun. 20, 2016.

(51) Int. Cl. B65F 3/04; B65F 3/02

(52) U.S. Cl. CPC B65F 3/041; B65F 2003/025; B65F 2003/0296

(57) ABSTRACT

An articulated front loader arm structure is provided for use with a conventional refuse collection vehicle having a conventional cab chassis. The articulated arm structure is controlled by a programmed logic controller (PLC) which for monitors and controls the movement of the front loader articulated arm structure. The PLC communicates with various cylinders and sensors to control the extension/retraction of the various cylinders associated with the various arm sections of the front loader arm structure during movement through both its container dump cycle and its container return cycle. The articulated arm structure allows the present front loader arm mechanism to both extend over a conventional cab chassis as well as to be stored on top of the refuse vehicle under the current legal height restriction of 13 feet, 6 inches.

### CROSS REFERENCE TO RELATED APPLICATIONS

This application is a non-provisional application claiming priority to provisional Patent Application Ser. No. 62/352,326 filed Jun. 20, 2016, the entire disclosure of which is incorporated herein by reference.

### BACKGROUND OF INVENTION

The present invention relates generally to front loader arm mechanisms associated with refuse collection vehicles and, more particularly, to a novel articulated front loader arm structure for use with a conventional refuse collection vehicle having a conventional cab chassis wherein a programmed logic controller (PLC) monitors and controls the movement of the front loader articulated arm structure and communicates with various cylinders and sensors to control the extension/retraction of such cylinders during movement through both its container dump cycle and its container return cycle. The articulated arm structure further allows the present front loader arm mechanism to be stored on top of the vehicle under the current legal height restriction of 13 feet, 6 inches.

Various types of refuse collection vehicles are well known in the industry. Such refuse collection vehicles typically include a refuse collection vehicle body positioned on a vehicle chassis where the vehicle chassis includes a cab or operator compartment for housing the vehicle operator, a frame structure for holding the refuse collection vehicle body including an appropriate number of wheels for carrying the designated load, and an engine for powering the vehicle and the hydraulic and/or pneumatic systems associated therewith.

Depending upon the particular task at hand, that is, whether the refuse collection vehicle is being used for residential or commercial purposes, the vehicle body will typically include a storage compartment and a mechanism for emptying the refuse material collected within the storage compartment. The storage compartment typically includes a somewhat rectangular straight body design and a rear access door for allowing egress of the stored refuse or waste material from the storage compartment. The rear access door is typically a pivotally mounted tailgate associated with the rear portion of the storage compartment. Typically, the tailgate is activated by a pair of hydraulic lift cylinders to open and close the tailgate. The refuse material can be egressed from the storage compartment through conventional ejection systems. Where a refuse container or dumpster is to be emptied into the storage compartment, the refuse collection vehicle will likewise include a front loader arm mechanism for engaging, elevating and dumping the refuse container or dumpster into the storage compartment of the vehicle.

Whenever the known prior art front loader arm mechanism is utilized on a refuse collection vehicle, the conventional cab chassis arrangement is not utilized because the overall structure of the known front loader arm mechanism cannot fully extend over the conventional cab arrangement. Instead, a modified cab arrangement such as the cab over engine (COE) or a low cab over engine (LCOE) cab arrangement is utilized. This modified cab arrangement accommodates the known front loader arm structure as will be hereinafter explained.

FIG. 1 illustrates a typical prior art refuse collection vehicle 10 having a COE cab compartment 12, the vehicle 10 being equipped with the known prior art front loader arm mechanism 14 for engaging a refuse container or dumpster and lifting the refuse container over the cab compartment 12 to a dumping position. The vehicle 10 also includes a storage compartment 16 in which refuse is dumped and collected. Typically, the front loader arm mechanism 14 is a one piece design which is pivotally attached to the vehicle frame structure on each opposite side of cab compartment 12 at respective pivot arm assemblies 18. Movement of the front loader arm mechanism 14 between its lowered position as illustrated in FIG. 1 and its raised or dump position (not shown) is controlled by a corresponding pair of arm lift cylinders 20, one cylinder 20 being located on each respective side of the vehicle 10 between the storage compartment 16 and the cab compartment 12. A forklift assembly 22 is pivotally attached to the terminal end portion of the front loader arm mechanism 14 at respective pivot assemblies 24, which movement is controlled by a respective pair of fork cylinders 26.

As illustrated in FIG. 1, the front loader arm mechanism 14 is shown in its lowered position preparatory to engaging a refuse container or dumpster, but the fork assembly 22 is shown in its collapsed position. Obviously, prior to engaging a typical refuse container, fork assembly 22 would be lowered to approximately a horizontal position relative to the ground and the fork assembly 22 would be positioned to engage corresponding engagement means associated with the container or dumpster for allowing the fork assembly 22 to hold the refuse container in a stable position during the dumping cycle. Once the refuse container is attached to the fork assembly 22, transfer of the refuse material contained within the dumpster to the storage compartment 16 is accomplished by retracting the arm lift cylinders 20 which allows the front loader arm mechanism 14 to start moving upward to its dumping position over the storage compartment 16 as best indicated by the location of reference numeral 28 in FIG. 1. Because of the structure of the front loader arm mechanism 14, a modified cab structure (COE or LCOE) must be utilized as the arm structure 14 is not of sufficient length to extend over a conventional cab chassis arrangement as will be hereinafter further explained.

In addition, the prior art front loader arm mechanism 14 is typically stowed for road travel either in the position as illustrated in FIG. 1, or in a slightly elevated position wherein the fork assembly 22 rides in the vicinity of the upper portion of cab 12. Due to the current legal height restriction for refuse collection vehicles of 13 feet, 6 inches, the prior art front loader arm mechanisms such as the mechanism 14 illustrated in FIG. 1 cannot be rotated to its dump position 28 above the storage compartment 16 for road travel as the fork assembly 22 will ride or extend above the legal height limit of 13 feet 6 inches. As a result, the prior art front loader arm mechanism 14 cannot be stowed for road travel on top of the vehicle 10.

It is therefore desirable to have a front loader arm mechanism capable of extending over a conventional refuse collection cab chassis, and which is capable of being stored on top of the collection vehicle over the storage compartment during road travel and still meet the current legal height restriction of 13 feet, 6 inches.

The present invention seeks to overcome the shortcomings and disadvantages associated with the known prior art front loader arm mechanisms by articulating the front loader arm structure and controlling its movement through the use of a pair of arm lift cylinders, a pair of arm hinge cylinders, and a programmed logic controller (PLC) or other controller mechanism which will control the lift and hinge cylinders and the articulated movement of the present front loader and mechanism through both its dump cycle and its return cycle while, at the same time, allowing the present front loader arm mechanism to extend over a conventional cab chassis.

In addition, the present invention also allows the present front loader arm mechanism to be stowed above the vehicle over the storage compartment at a height which is under the legal height restriction of 13 feet 6 inches. Still further, the fork assembly associated with the present front loader arm mechanism includes a position sensor which likewise communicates with the PLC to store the angular position of the front arm relative to the fork assembly when the dumpster is engaged, so that when the dumpster is returned to a ground surface after dumping, the dumpster can be returned to that stored angular position and thus be substantially level on the surface from which it was lifted.

### SUMMARY OF INVENTION

The present invention overcomes many of the shortcomings and limitations associated with the known prior art front loader arm mechanisms discussed above and teaches the construction and operation of an articulated front loader arm structure which is specifically adaptable for use with a conventional refuse collection vehicle extended cab compartment.

In one aspect of the present invention, the present articulated front loader arm mechanism includes a pair of front arm sections pivotally attached to a pair of rear arm sections having a pair of arm hinge cylinders positioned and located therebetween for allowing the front arm sections to move in relationship to the rear arm sections. A forklift assembly is likewise pivotally attached adjacent the terminal end portion of the front arm sections and its movement relative to the front arm sections is controlled by a pair of fork cylinders. The forklift assembly includes a pair of forklift arms which can be positioned and maneuvered to engage a refuse container or dumpster so that the refuse material contained within the dumpster can be transferred to a storage compartment associated with the refuse collection vehicle via operation of the present articulated front loader arm mechanism.

In this regard, the present articulated front loader arm mechanism is movable between a first position where a dumpster engaged with the forklift assembly is resting on a support surface at or near ground level, and a second position where the dumpster is located over the storage compartment of the vehicle in a dump position. Movement of the present arm mechanism between its first and second positions will be hereinafter referred to as the container dump cycle and movement of the present arm mechanism from its second position back to its first position will be hereinafter referred to as the container return cycle.

Movement of the present articulated front loader arm mechanism is controlled by a pair of arm lift cylinders, a pair of arm hinge cylinders, and a pair of fork cylinders. Each of the cylinders communicate with a programmed logic controller (PLC) or other system controller or processor means which monitors and controls the extension and retraction of the arm lift, arm hinge, and forklift cylinders relative to each other as the present front loader arm mechanism moves during both its container dump cycle and its container return cycle. The PLC or system controller monitors the position of the cylinders during movement of the front loader arm mechanism through the use of sensors associated with such cylinders so as to ensure that the front arm sections, the forklift assembly and any refuse container or dumpster engaged therewith will not hit or otherwise make contact with the hood area or the cab compartment associated with the refuse vehicle during its cycle movements.

The PLC farther monitors the angular position of the forklift arms relative to the terminal end portion of the front arm sections through the use of an additional position sensor associated with the forklift assembly. The position sensor measures the angular position of the forklift arms relative to the terminal end portion of the front arm sections upon engaging the dumpster, and it stores that angular position in its memory until the stored angular position is again used at the initiation of the dumpster's return cycle, as further explained below.

The container dump cycle starts with the present articulated front loader arm mechanism being positioned by the vehicle operator using a joystick or other mechanism such that the forklift arms are at a height for engaging the engagement means associated with a typical refuse container or dumpster. When a refuse container is engaged with the forklift arms, the arm lift cylinders are near full extension, the arm hinge cylinders are at full extension, and the forklift cylinders are extended so that the forklift arms are in position to engage the refuse container. Once a refuse container is engaged with the forklift assembly, the position sensor associated with the forklift assembly measures the angular position of the forklift arms relative to the terminal end portion of the front arm sections and sends a signal to the PLC including that angular orientation for subsequent use.

The operator will then activate the PLC through a control panel, joystick and/or other control mechanism in the cab compartment to start the container dump cycle. When activated, the PLC will start to retract the arm lift cylinders, allowing the front loader arm mechanism to start its movement upward towards its dump position. When the arm lift cylinders reach a pre-determined location which coincides with the refuse container being lifted to a pre-determined position such as just over the hood area of the vehicle, the PLC will signal the arm hinge cylinders to start their retraction. This ensures that the front arm sections and the refuse container will not hit or otherwise make contact with the hood area of the vehicle. At a predetermined location programmed into the PLC, the PLC will send a signal to the forklift cylinders to further extend so as to keep the refuse container or dumpster somewhat level with the ground during this portion of its movement towards the dump position.

During the container dump cycle, as the arm hinge cylinders retract, the PLC will continuously monitor the location of the arm hinge cylinders relative to the location of the arm lift cylinders to ensure that the position of the respective cylinders are within a pre-determined range programed within the PLC. This is necessary to ensure that the front arm sections, the forklift assembly and the refuse container or dumpster engaged therewith will clear the cab compartment and any cab shield positioned above the cab compartment during movement of the present articulated front loader arm mechanism during the remainder portion of its travel to its dump position. If, for example, the arm hinge cylinders are not within the pre-determined range programmed into the PLC, the PLC will either slow down the retraction of the arm hinge cylinders or slow down the retraction of the arm lift cylinders as needed so as to keep movement of the respective front and rear arm sections within a pre-determined range to again ensure that no portion of the arm structure or the dumpster will contact any portion of the refuse vehicle.

When the arm lift cylinders and the arm hinge cylinders reach full retraction, the refuse container will be located above the refuse vehicle and over the storage compartment and, at this point, the PLC will send a signal to the forklift cylinders to retract the forklift cylinders thereby rotating the refuse container or dumpster to dump the contents of the refuse container into the storage compartment. After the refuse container is emptied, the PLC will again send a signal to the forklift cylinders to extend the forklift cylinders to again partially rotate the refuse container or dumpster away from its dump positions, and it will also send a signal to slightly extend the arm hinge cylinders while leaving the arm lift cylinders retracted. This allows the front arm section to have sufficient clearance between itself and the top of the refuse vehicle before the container return cycle is initiated. The forklift cylinders will initially extend such that the angular orientation between the forklift arms and the terminal end portion of the front arm sections will be the same as the angular position stored in the PLC that was measured when the dump cycle was initiated. That way, when the dumpster is returned to its ground surface upon completion of the dumpster return cycle, it will be substantially level with that ground surface.

After the arm hinge cylinders reach a pre-determined location during its extension after the dump cycle has been completed, the PLC will send a signal to the arm hinge cylinders to continue to extend while likewise sending a signal to the arm lift cylinders to begin their extension. This will now start movement of the present articulated front loader arm mechanism on its return cycle. Like the dump cycle, the PLC will monitor the location of the arm lift cylinders and the arm hinge cylinders relative to each other during its return cycle to again ensure that the correct relationship between the cylinders is maintained throughout the entire return cycle. This similarly ensures that the refuse container, forklift assembly and/or the front arm sections of the present arm mechanism will not contact any portion of the vehicle during its return cycle. The arm hinge cylinders will reach full extension when the container is generally over the hood area of the vehicle, and the arm lift cylinders will be still extending. The arm lift cylinders will continue to extend until the container is on the ground.

Because of the articulation between the front and rear arm sections of the present front loader arm mechanism, the present mechanism can be fabricated to extend over a conventional refuse collection cab chassis. In addition, because of this same articulation, the front arm sections as well as the forklift assembly can be positioned and oriented for road travel on top of the refuse vehicle and over the storage area at a height which is under the current legal height restriction of 13 feet, 6 inches for refuse collection vehicles. The pivoting of the front arm sections relative to the rear and sections allows for storage of the present front loader arm mechanism on top of the refuse vehicle during road travel, a stowed or travel position not obtainable with the known prior art front loader arm mechanisms. In addition, movement and control of the front and rear arm sections relative to each other as well as movement of the forklift assembly via a programmable logic controller or other system controller ensures that the front arm sections, the forklift assembly and/or a refuse container or dumpster attached to the forklift assembly will always clear the hood area and cab compartment of the vehicle during both its container dump cycle and its container return cycle.

Additional features of the present invention will be described and will become apparent to those skilled in the art during the course of the following detailed description.

### BRIEF DESCRIPTION OF DRAWINGS

For a better understanding of the present invention, reference may be made to the accompanying drawings.

FIG. 1 is a side elevational view of a typical refuse collection vehicle having an COE cab compartment and being equipped with a typical known prior art front loader arm structure.

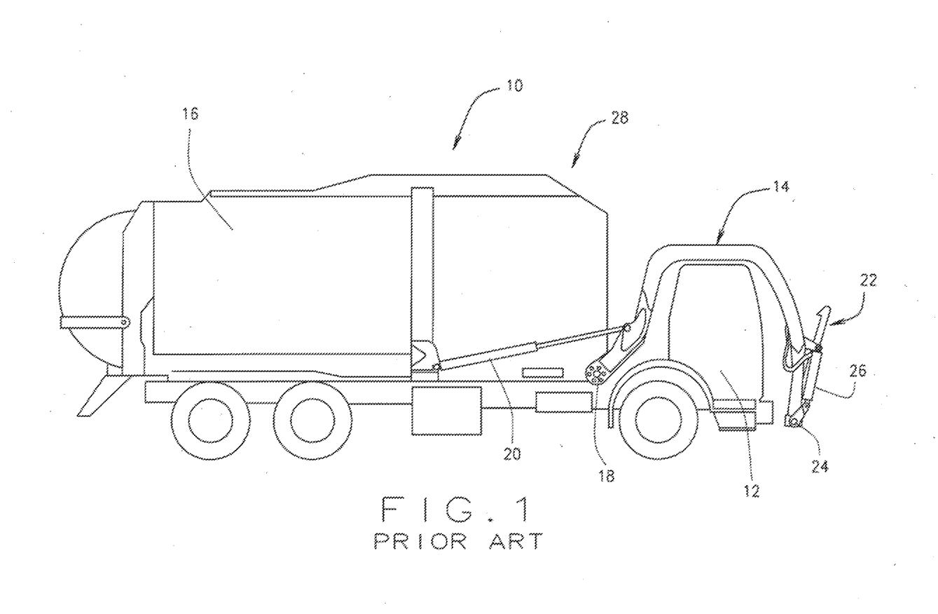

FIG. 2 is a perspective view of a typical refuse collection vehicle utilizing the present articulated front loader arm mechanism constructed in accordance with the teachings of the present invention.

FIG. 3 is a side elevational view of the refuse collection vehicle of FIG. 2 showing the present articulated front loader arm mechanism engaged with a refuse container at the beginning of its dump cycle.

FIG. 4 is a schematic diagram of one embodiment showing the operation of the PLC, position sensor, control panel and joystick for controlling and monitoring the movement of the lift, hinge and forklift cylinders and the present articulated front arm mechanism.

FIG. 5A is a partial side elevational view showing a first embodiment of the present position sensor associated with the terminal end portion of at least one front arm section and the forklift arms.

FIG. 5B is a partial side elevational view showing a second embodiment of the present position sensor associated with the terminal end portion of at least one front arm section and the forklift arms.

FIG. 6 is a partial side elevational view of FIG. 3 showing the present articulated front loader arm mechanism moving through a portion of the dump cycle.

FIG. 7 is a partial side elevational view of FIG. 3 showing the present articulated front loader arm mechanism moving through a further portion of the dump cycle.

FIG. 8 is a partial side elevational view of FIG. 3 showing the present articulated front loader arm mechanism at its dump position.

FIG. 9 is a partial side elevational view of FIG. 3 showing the present articulated front loader arm mechanism at the beginning of its return cycle.

FIG. 10 is a partial side elevational view of FIG. 3 showing the present articulated front loader arm mechanism moving through a portion of its return cycle.

FIG. 11 is a partial side elevational view of FIG. 3 showing the present articulated front loader arm mechanism moving through a further portion of its return cycle.

FIG. 12 is a partial side elevational view similar to FIG. 3 showing the present articulated front loader arm mechanism at its returned ground level position.

FIG. 13 is a side elevational view similar to FIG. 3 showing the present articulated front loader arm mechanism in its stowed road travel position.

### DETAILED DESCRIPTION OF THE INVENTION

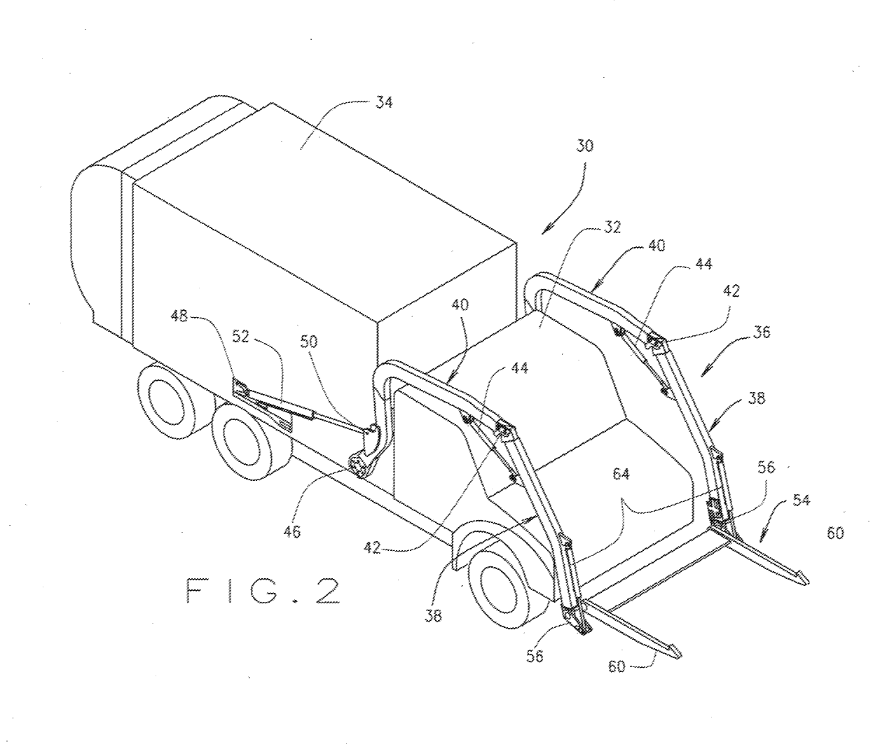

FIG. 2 illustrates a refuse collection vehicle 30 having a chassis including a conventional operator or cab compartment 32 and a storage compartment 34 in which refuse is dumped and collected during the refuse collection process described below. The storage compartment 34, which is substantially similar to storage compartment 16 described above, is generally rectangular in shape, though in alternative embodiments the storage compartment 34 could take on a different shape. The refuse collection vehicle 30 includes on its front portion the present articulated front loader arm mechanism 36. The construction and operation of the articulated front loader arm mechanism 36 allows the present mechanism to extend over a conventional refuse collection cab compartment such as cab compartment 32, rather than a COE, an LCOE or other modified cab compartment. In addition, the articulated front loader arm mechanism 36 can be positioned and oriented for road travel on top of the refuse vehicle 30 and over the storage compartment 34 at a height under the current legal height restriction of 13 feet, 6 inches for refuse collection vehicles as will be hereinafter further explained.

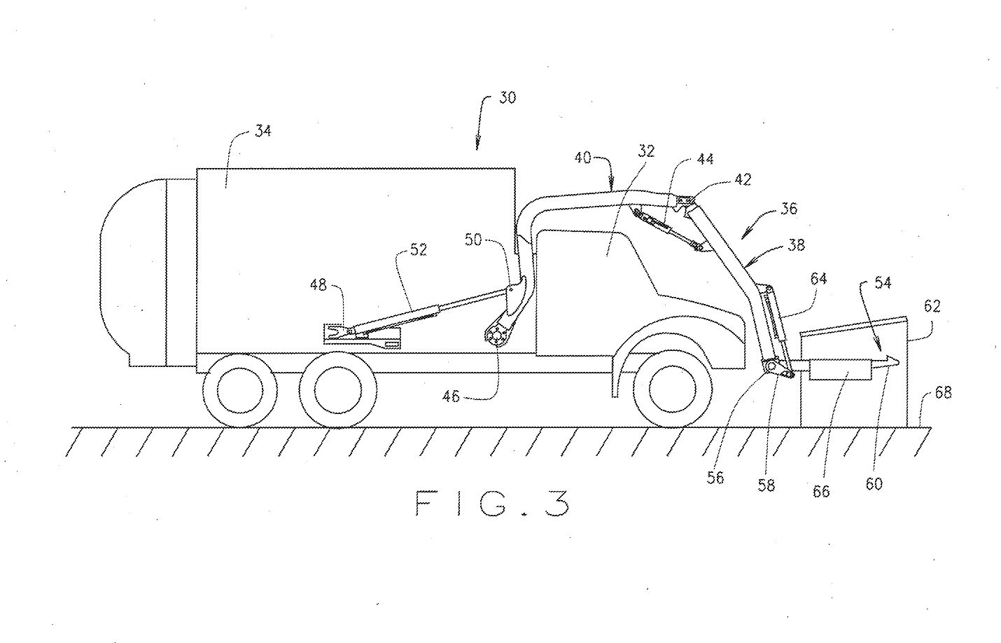

FIG. 3 illustrates the refuse collection vehicle 30 and the present articulated front loader arm mechanism 36 from a side elevational view, thus showing only one side of the collection vehicle 30 and one side of the articulated front loader arm mechanism 36. Because of their symmetrical construction, the opposite side of collection vehicle 30 and the opposite side of the articulated front loader arm mechanism 36 not illustrated in FIG. 3 are substantially similar to the sides shown in FIG. 3. FIG. 2 illustrates this symmetry.

The front loader arm mechanism 36 includes a pair of front arm sections 38 positioned and located on either side of vehicle 30. The front arm sections 38 are pivotally attached to a pair of rear arm sections 40 via a pair of first pivot arm assemblies 42. The pivot arm assemblies 42 pivotally attach the arm sections 38 and 40 to one another and also allow for the angular rotation of arm sections 38, 40 relative to one another. A pair of arm hinge cylinders 44 positioned and located between the front arm sections 38 and the rear arm sections 40 allow the front arm sections 38 to angularly move relative to the rear arm sections 40 when the front loader mechanism 36 is in operation as will be described below. The arm hinge cylinders 44 may be hydraulically or pneumatically operated as well known and understood in the art.

The rear arm sections 40 are pivotally attached to the storage compartment 34 or to any other portion of the refuse collection vehicle 30 via a pair of second pivot arm assemblies 46. The rear arm sections 40 are further attached to a pair of arm lift cylinders 52. One end portion of the respective arm lift cylinders are attached to the refuse collection vehicle 30 at a first fixed point 48 and their opposite end portions are attached to the rear arm sections 40 at a second fixed point 50. The arm lift cylinders 52 operate to allow rear arm sections 40 to rotate toward the rear of the vehicle 30 during operation of the loader mechanism 36. Like the arm hinge cylinders 44, the arm lift cylinders 52 may be hydraulically or pneumatically operated as well known and understood in the art.

A forklift assembly 54 is likewise pivotally attached to the terminal end portion of the front arm sections 38 via a pair of third pivot arm assemblies 56. The forklift assembly 54 includes a pair of forklift arms 60 which can be positioned and maneuvered to engage a refuse container or dumpster 62 (as shown in FIGS. 3 and 6-12) so that refuse material contained within the dumpster 62 can be transferred to the storage compartment 34 associated with the refuse collection vehicle 30 via operation of the present articulated front loader arm mechanism 36. Movement of the forklift assembly 54 and its forklift arms 60 relative to the front arm sections 38 is controlled by a pair of forklift cylinders 64. The forklift cylinders 64 each have one end portion attached to a respective front arm section 38 and each have their opposite end portions attached to a respective flange 58 associated with the respective third pivot arm assemblies 56. Like cylinders 44 and 52, the fork cylinders 64 may also be either hydraulically or pneumatically operated.

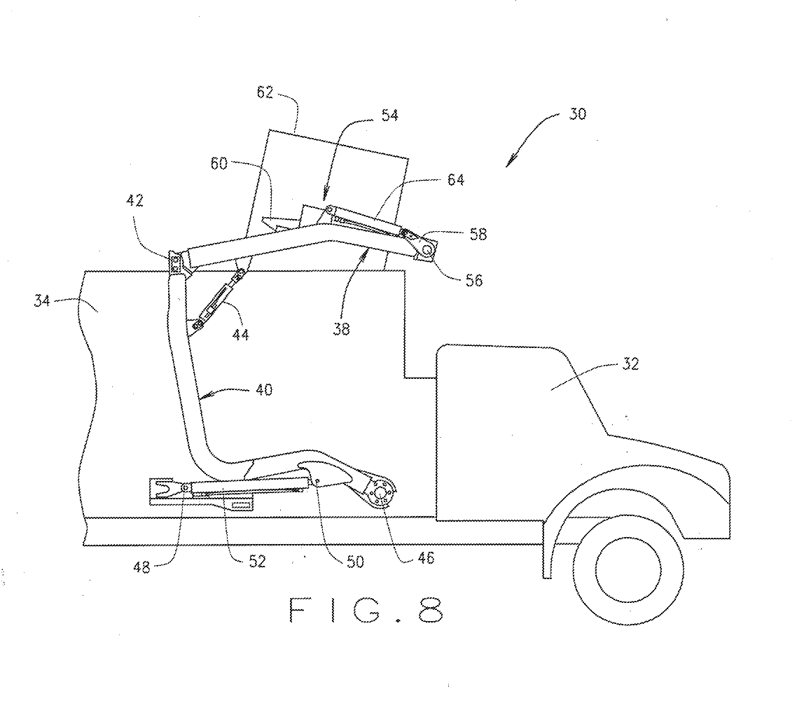

In this regard, the present articulated front loader arm mechanism 36 is movable between a first position where a dumpster such as dumpster 62 engaged with the forklift assembly 54 via engagement means 66 on the dumpster 62 is resting on a support surface 68 at or near ground level, such as shown in FIG. 3, and a second position where the dumpster 62 is located over the storage compartment 34 of the vehicle 30 in a dump position, such as shown in FIG. 8. Movement of present arm mechanism 36 between its first and second positions is hereinafter referred to as the container dump cycle, and movement of the arm mechanism 36 from its second position back to its first position is hereinafter referred to as the container return cycle.

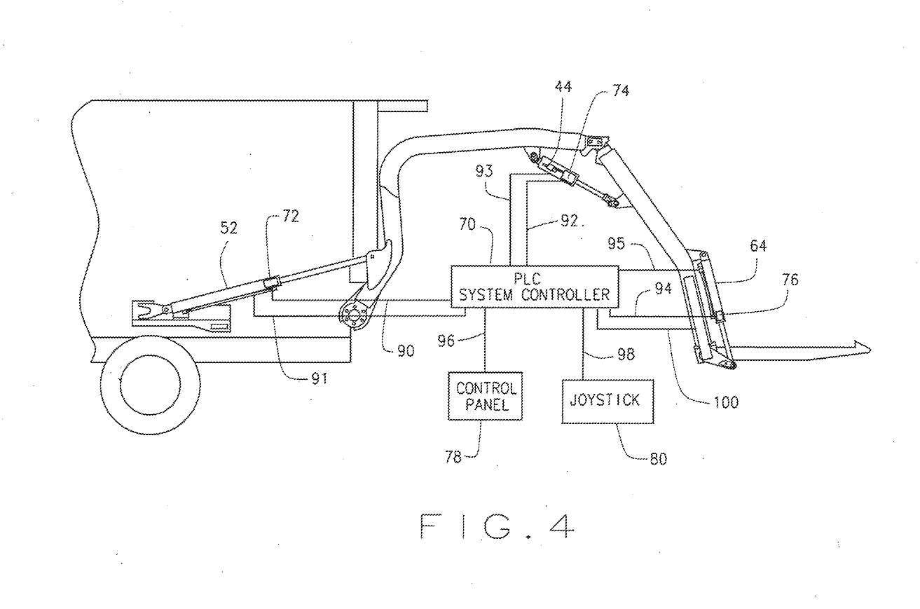

The schematic diagram of FIG. 4 illustrates the interaction and communication between the arm lift cylinders 52, the arm hinge cylinders 44, the forklift cylinders 64 and a programmed logic controller (PLC) 70 which measures, monitors, and controls the extension and/or retraction of the arm lift cylinders 52, the arm hinge cylinders 44, and forklift cylinders 64 as the present front loader arm mechanism 36 moves during both its container dump cycle and its container return cycle, The PLC 70 may be of the type commonly known or understood in the art, and thus should act as a digital computer used for automation. As an alternative to the PLC 70, any system controller or processor means which is able to monitor or control the extension and retraction of the cylinders 52, 44, 64 relative to each other may be used.

The PLC 70 or other system controller monitors and/or adjusts the position of the arm lift cylinders 52, the arm hinge cylinders 44, and forklift cylinders 64 during movement of the front loader arm mechanism 36 via its communication with an arm lift sensor 72, an arm hinge sensor 74, and a forklift sensor 76 as well as communication with the respective cylinders. The sensors 72, 74, and 76 may be of any type suitable for measuring the relative extension and retraction positions of the arm lift cylinders 52, the arm hinge cylinder 44 and the forklift cylinders 64 as well as the relative positions of the arm sections 40, 38 and/or the forklift assembly 54. The communication between the PLC 70 and the sensors 72, 74, and 76 via conductive paths 90, 92 and 94 and communication between the PLC 70 and the respective cylinders 52, 44 and 64 via conductive paths 91, 93 and 95 may be either of wired or wireless communication. The PLC 70 may be physically located in a number of different locations on the vehicle 30, such as in the cab compartment 32, where a user can operate the PLC 70. The sensors 72, 74, 76 are illustrated as associated with the cylinders 52, 44, 64 in FIG. 4, but in other embodiments, the sensors 72, 74, 76 may be built into the cylinders 52, 44, 64 or otherwise associated with the cylinders 52, 44, 64.

The sensors 72, 74, 76 ensure that the cylinders 52, 44, 64 do not retract and/or extend too quickly and thus cause uncontrolled and potentially dangerous movements of any of the rear arm sections 40, front arm sections 38, or the forklift assembly 54. The sensors 72, 74, 76 also measure the relative positions of the rear arm sections 40, front arm sections 38, and/or forklift assembly 54, and using a predetermined algorithm, the PLC 70 continuously monitors the cylinders 52, 44, 64 to ensure that the front arm sections 38 and the forklift assembly 54 and any refuse container or dumpster such as dumpster 62 engaged therewith do not hit or otherwise make contact with the hood area or the cab chassis 32 associated with the refuse vehicle 30 during its cycle movements.

The PLC 70 is also used to initiate and otherwise operate the arm mechanism 36 and its cylinders 52, 44, 64 during its dump cycle and its return cycle. PLC 70 may be operated to initiate the dump cycle, return cycle, or the operation of any of cylinders 52, 44, 64 by way of a user interface such as a control panel 78, a joystick 80 and/or other control mechanism compatible with the operation of the arm mechanism 36 as described herein (the schematic diagram of FIG. 4 illustrates this relationship). The control panel 78, joystick 80 and/or other control mechanism used to control the PLC 70 and the arm mechanism 36 are operatively connected to the PLC 70 via conductive paths 96 and/or 98 and are of a type known or foreseeable in the art able to be in electrical and/or data communication with the PLC 70. The control panel 78, joystick 80 and/or other control mechanism are preferably located in the cab chassis compartment where an operator is seated when operating the front loader and mechanism 36. The PLC 70, through user interfaces 78, 80 or other mechanisms, controls the respective cylinders 52, 44 and 64 via conductive paths 91, 93, 95 or some other known mechanism.

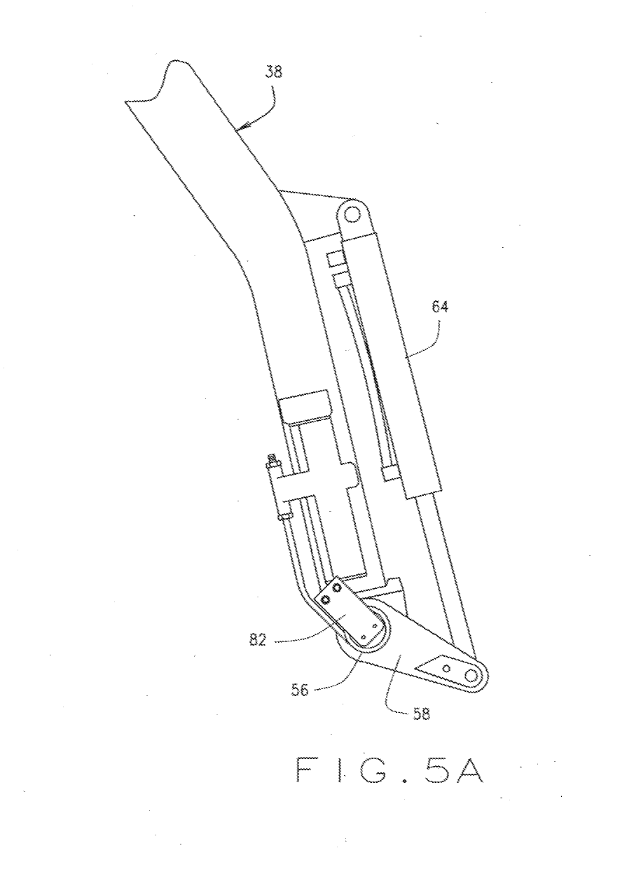

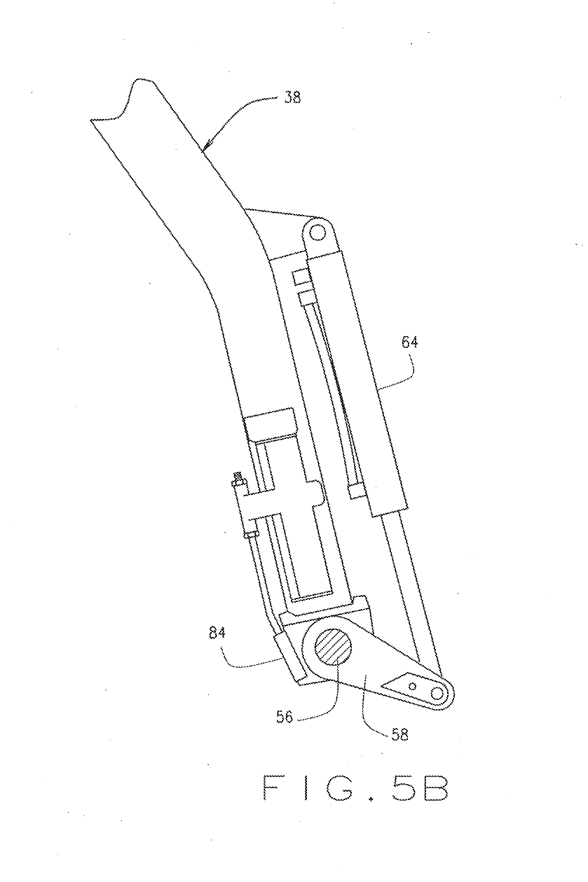

The PLC 70 also monitors and measures the angular position of the forklift arms 60 relative to the terminal end portion of at least one front arm section 38 through the use of a position sensor 82 associated with the forklift assembly 54 as shown in FIG. 5A. The position sensor 82 is illustrated in FIG. 5A as a rotary sensor 82. An alternative position sensor 84 is also illustrated in FIG. 5B as a linear sensor 84. Either of the position sensors 82 or 84 are in communication with the PLC 70 via conductive path 100 and either sensor may be any type so long as it is able to monitor and measure the angular position of the forklift arms 60 relative to the terminal end portion of at least one front arm section 38. Position sensors 82 or 84 and their relative functions during the operation of the articulated arm mechanism 36 are discussed in detail when further describing the operation of the articulated arm mechanism 36 below.

FIG. 3 illustrates a side elevational view of the loader arm mechanism 36 at the start of its container dump cycle. The container dump cycle starts with the present articulated front loader arm mechanism 36 being maneuvered and positioned by the vehicle operator using the control panel 78, the joystick 80, or some other interface mechanism to operate the PLC 70 such that the forklift arms 60 are at a height for engaging the engagement means 66 associated with a typical refuse container such as dumpster 62.

When the dumpster 62 is engaged with the forklift arms 60 via engagement means 66 in a manner known, the arm lift cylinders 52 are at or near full extension, the arm hinge cylinders 44 are at or near full extension, and the forklift cylinders 64 are extended so that the forklift arms 60 are engaged with the dumpster 62. After the dumpster 62 is engaged with the forklift assembly 54, the position sensor 82 or 84 (illustrated in FIGS. 5A and 5B) associated with the forklift assembly 54 measures the angular position of the forklift arms 60 relative to the terminal end portion of the front arm sections 38 and sends a signal to the PLC 70 via conductive path 100 including that angular position measurement, which the PLC 70 stores in a memory (not illustrated). The angular orientation measurement of the forklift arms 60 relative to the terminal end portion of the front arm sections 38 will again be used after the dumpster 62 has been dumped and the front loader arm mechanism 36 is maneuvered to start its return cycle.

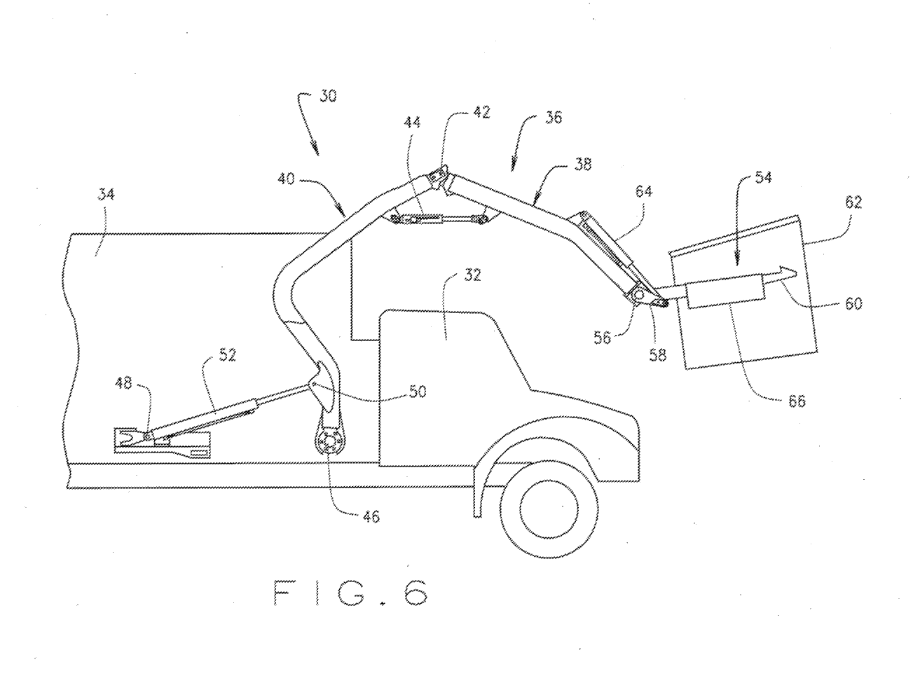

When activated, the PLC 70 will first send a signal via conductive path 91 to retract the arm lift cylinders 52. The retracting of arm lift cylinders 52 allows front loader arm mechanism 36 with dumpster 62 attached thereto to initiate its movement upward towards its dump position. The dumpster 62 having begun its upward ascent is illustrated in FIG. 6, where arm lift cylinders 52 are shown in a partially retracted position. In this position, the arm lift cylinders 52 have reached a pre-determined location which coincides with the dumpster 62 being lifted to a pre-determined position such as just over the hood area of the vehicle 30. This pre-determined location which is read and measured by sensors 72, 74, 76 is sent to the PLC 70 via conductive paths 90, 92 and 94 which then will signal via conductive paths 93 the arm hinge cylinders 44 to start their retraction. The arm lift cylinders 52 beginning their retraction prior to the arm hinge cylinders 44 ensures that the front arm sections 38 and the refuse container 62 do not hit or otherwise make contact with the hood area of the vehicle 30 thus potentially damaging vehicle 30.

At the same time, when the refuse container 60 is at a position such as just over the hood area of the vehicle 30 or a different position and location pre-programmed into the PLC 70, the PLC 70 will send a signal via conductive path 95 to the forklift cylinders 64 to extend a pre-determined amount so as to keep the refuse container 62 somewhat level with the ground during this portion of its movement towards the dump position. If the forklift cylinders 64 did not extend as set forth above, the refuse container 62 would be angled inwardly toward the vehicle 30 to the point of risking dumping refuse prematurely onto the cab compartment or other parts of the vehicle 30 during its ascent to the dump position rather than in the storage compartment 34. This not only could defeat the purpose of the entire dump cycle, but it also could pose a danger to the operator within cab compartment 32 or cause damage to the vehicle 30.

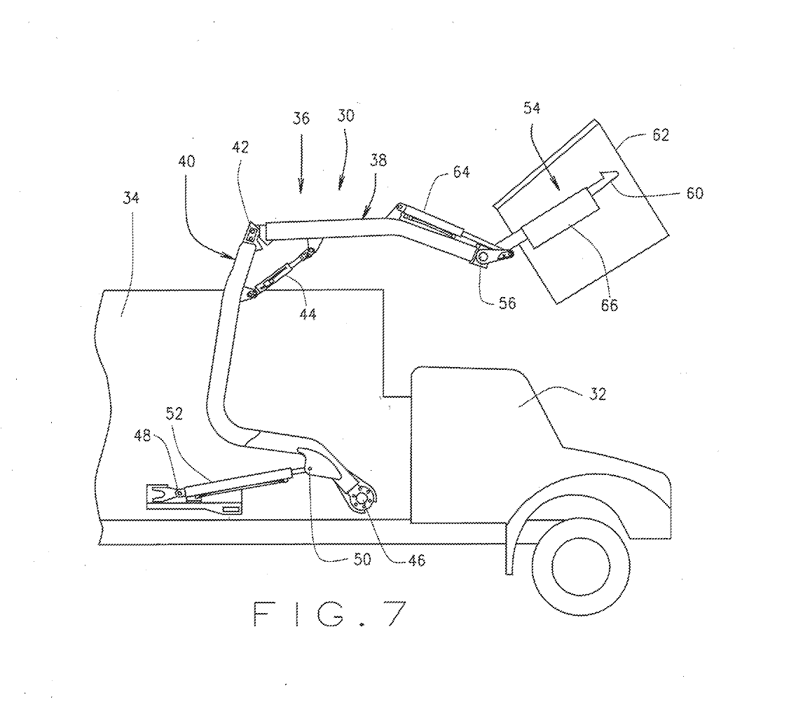

Continuously throughout the duration of the container dump cycle, as the arm lift cylinders 52 and arm hinge cylinders 44 are retracted, the PLC 70 will monitor the location of the arm hinge cylinders 44 relative to the location of the arm lift cylinders 52 via conductive paths 90 and 92 to ensure that the respective positions of the cylinders are within a pre-determined range programed within the PLC and to further ensure that the cylinders are not retracting too quickly. If cylinders 52, 44 are moving too quickly or too slowly relative to one another, the dumping cycle could take place prematurely prior to reaching the storage compartment 34. This continuous monitoring is also necessary to ensure that the front arm sections 38, the forklift assembly 56, and the refuse container 62 engaged therewith will likewise clear the cab chassis 32 and any cab shield (not illustrated) positioned above the cab chassis during movement of the present articulated front loader arm mechanism 36 during the remainder portion of its travel toward the dump position as best illustrated in FIG. 7. FIG. 7 is a partial side elevational view showing the present arm mechanism 36 and attached dumpster 62 clear of the cab compartment 32 and moving through a further portion of the dump cycle.

In order to avoid the aforementioned undesirable scenarios, if the arm hinge cylinders 44 are not retracting within the pre-determined range programmed into the PLC 70 during the dump cycle, the PLC 70 will either slow down the retraction of the arm hinge cylinders 44 or slow down the retraction of the arm lift cylinders 52 as needed. That way the respective front and rear arm sections 38, 40 remain within a pre-determined range so that no portion of the front loader arm mechanism 36 or the dumpster 62 will contact and/or damage any portion of the refuse vehicle 30. It is the articulation between the front and rear arm sections 38, 40 of the present front loader arm mechanism 36 that allows the present mechanism 36 to be fabricated such that it is able to extend over a conventional refuse collection cab chassis such as cab chassis 32.

After some time of retracting, the arm lift cylinders 52 and the arm hinge cylinders 44 reach full retraction, and the refuse container 62 is located above the refuse vehicle 30 and over the storage compartment 34, as shown in FIG. 8. It is at this moment that the PLC 70 sends a signal to the forklift cylinders 64 via conductive path 95 to retract the forklift cylinders 64 thereby rotating the dumpster 62 toward the rear of the vehicle. The contents of the refuse container or dumpster 62 are then dumped into the storage compartment 34 as illustrated in FIG. 8.

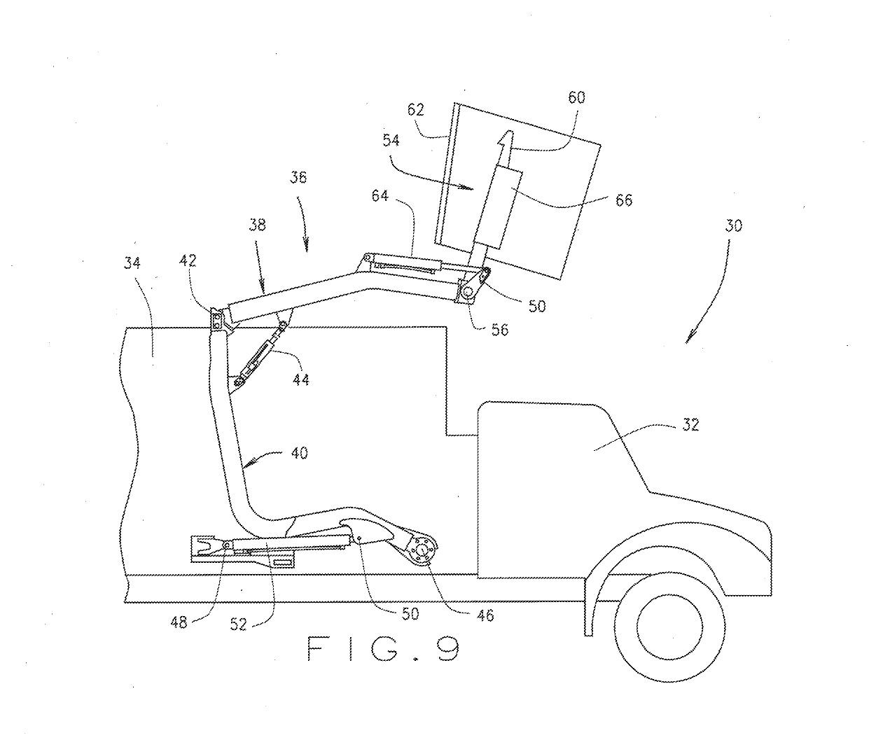

After the refuse container is emptied, the PLC 70 will again send a signal to the forklift cylinders 64 to extend the forklift cylinders 64 to initiate the rotation of the refuse container 62 away from its dump position. The PLC 70 will also simultaneously send a signal to the arm hinge cylinders 44 via conductive path 93 to begin extending, while leaving the arm lift cylinders 52 retracted. This allows the front arm section 38 to clear itself away from the top of the refuse vehicle 30 before the container return cycle is initiated, as shown in FIG. 9.

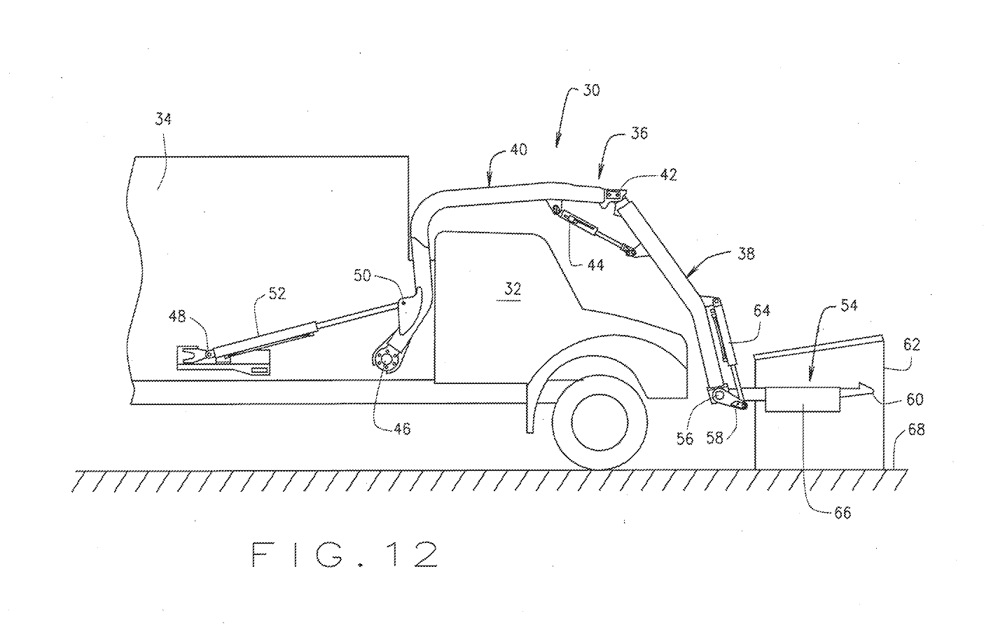

Next, the PLC 70 further instructs the forklift cylinders 64 via conductive path 95 to extend to the same angular position between the forklift arms 60 and the terminal end portion of the front arm sections 38 measured by the position sensor 82 or 84 previously stored in the PLC at the initiation of the dump cycle. The forklift arms 60 having returned to the stored angular position relative to the front arm sections 38 shown at the start of the dump cycle in FIG. 3 is again shown in FIG. 9. In this angular position, the dumpster 62 will be substantially parallel to the ground surface when the dumpster 62 is returned to its starting position as illustrated in FIG. 12. Depending on how the PLC 70 is programmed, the forklift cylinders 64 may extend such that the forklift arms 60 are completely returned to the stored angular position relative to the front arm section 38 before the arm hinge cylinders 44 extend rather than the arm hinge cylinders 44 extending at the same time as the forklift cylinders 64.

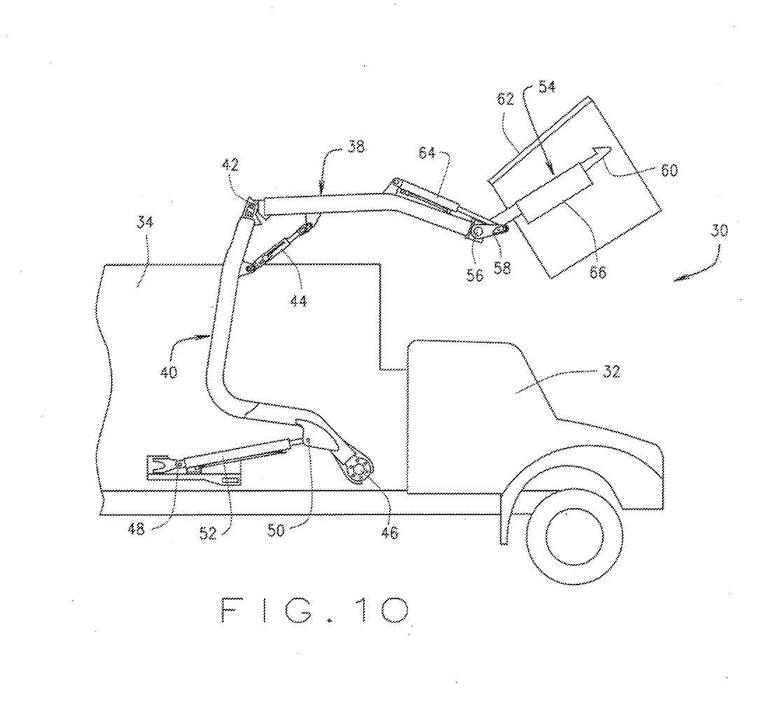

After the arm hinge cylinders 44 reach a pre-determined location which is stored in the PLC 70 during extension after the dump cycle has been completed, the PLC 70 will signal the arm hinge cylinders 44 via conductive path 93 to continue to extend while likewise signaling the arm lift cylinders 52 via conductive path 91 to initiate their extension. These signals from the PLC 70 initiate the return cycle of the front loader arm mechanism 36. FIG. 10 is a partial side elevational view showing the present arm mechanism 36 moving through a portion of its return cycle.

As with the dump cycle, the PLC 70 continuously monitors the location of the arm lift cylinders 52 and the arm hinge cylinders 44 relative to one other during its return cycle. This continuous monitoring allows the PLC 70 to again ensure that the correct relationship between the cylinders 52, 44 is maintained throughout the entire return cycle. If necessary, the PLC 70 can instruct one or both of the cylinders 52, 44 to extend at an increased or decreased rate in order to prevent the dumpster 62, forklift assembly 54 and/or the front arm sections 38 of the present arm mechanism 36 from contacting and/or causing damage to any portion of the vehicle 30 including its cab compartment 32 during the return cycle.

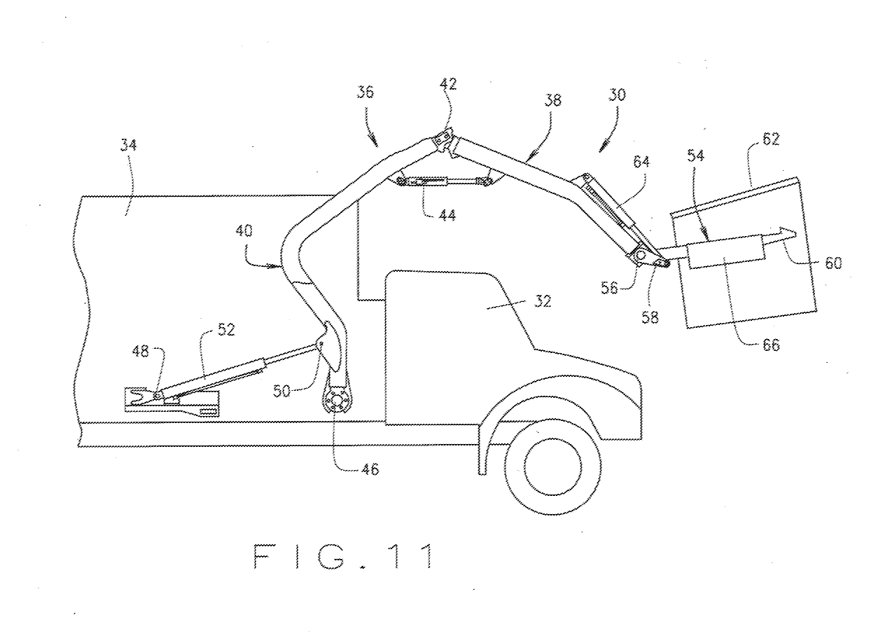

Preferably, the arm hinge cylinders 44 will reach full extension when the refuse container 62 is generally over the hood area of the vehicle 30, prior to the arm lift cylinders 52 reaching their full extension. The arm hinge cylinders 44 having reached full extension prior to the arm lift cylinders 52 having reached full extension is shown in FIG. 11.

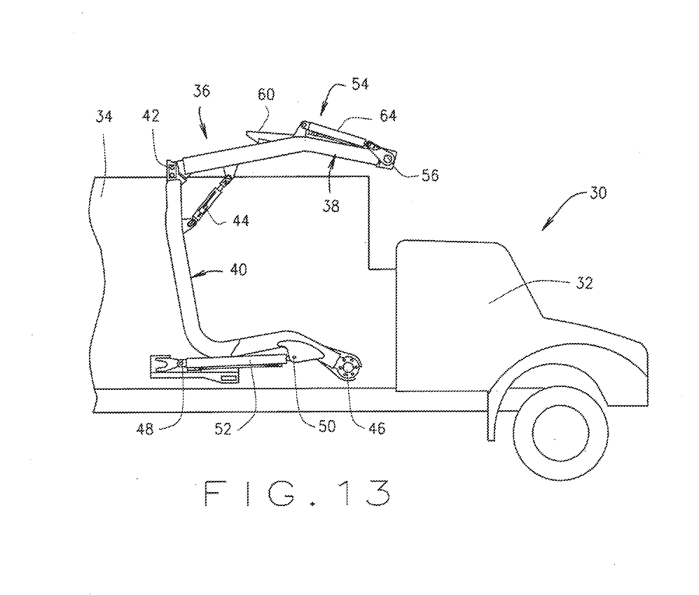

FIG. 12 shows completion of the return cycle, with the arm lift cylinders 52 continuing to extend until the refuse container 62 is on the ground. At this moment the vehicle 30 is able to reverse away from the dumpster 62 such that the forklift arms 60 disengage the dumpster 62 and its engagement means 66. The PLC 70 may then signal the arm lift cylinders 52, arm hinge cylinders 44, and forklift cylinders 64 via conductive paths 91, 93 and 95 to all retract at a preprogrammed rate to a pre-determined position after the return cycle has been completed. One such position can be a road travel position located on top of the refuse vehicle and over the storage area 34 as best illustrated in FIG. 13. The cylinders 52, 44, and 64 retract at a rate which prevents the front arm sections 38 and/or forklift assembly 56 from making contact and/or damaging the hood or cab compartment 32 of vehicle 30. Thus, the arm lift cylinders 52 preferably retract first such that the front arm sections 38 and forklift assembly 56 are lifted upwardly away from the cab chassis 32. Movement of the front loader arm mechanism 36 to its road travel position can also be accomplished by activating the dump cycle with no dumpster engaged, with the front loader arm mechanism 36.

Once the articulated front loader arm mechanism 36 is in its fully stowed position, the vehicle 30 is prepared for road travel. FIG. 13 illustrates the articulated front loader arm mechanism 36 in its fully stowed position. In the fully stowed position, all cylinders 52, 44, and 64 are fully retracted, and the rear arm sections 40 are positioned and located at the side of the storage compartment 34, and below the top edge portion of the storage compartment 34. In the stowed position, the front arm sections 38 and forklift assembly 56 are positioned and located just above the storage compartment 34. The front arm sections 38 as well as the forklift assembly 54 are stowed on top of the refuse vehicle 30 and over the storage compartment 34 at a height which is under the current legal height restriction of 13 feet 6 inches for refuse collection vehicles such as vehicle 30.

It is because of the articulation between the front and rear arm sections 38 and 40 the present arm mechanism 36 can both extend over a conventional cab chassis and retract to a storage position on top of the vehicle for road travel and still stay below the current legal height restriction of 13 feet 6 inches for refuse collection vehicles. It is the arm hinge cylinders 44 that allow for the novel articulation of the arm mechanism 36 as explained above.

From the foregoing, it will be seen that the various embodiments of the present invention are well adapted to attain all the objectives and advantages hereinabove set forth together with still other advantages which are obvious and which are inherent to the present structures. Since many possible embodiments of the present invention may be made without departing from the spirit and scope of the present invention, it is to be understood that all disclosures herein set forth or illustrated in the accompanying drawings are to be interpreted as illustrative only and not limiting. The various constructions described above and illustrated in the drawings are presented by way of example only and are not intended to limit the concepts, principles and scope of the present invention.

Thus, there has been shown and described several embodiments of a novel articulated front loader arm mechanism. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required.”

Many changes, modifications, variations and other uses and applications of the present constructions will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. An articulated front loader arm structure for use with a refuse collection vehicle having a conventional cab compartment and a storage compartment, the articulated front loader arm structure being engagable with a dumpster for emptying the contents of the dumpster into the storage compartment of the vehicle, the articulated front arm loader structure comprising:
a forklift assembly including a pair of forklift arms for engaging a dumpster;
a pair of front arm sections pivotally attached to said forklift assembly;
a pair of forklift cylinders attached to said forklift assembly and to said front arm sections for pivotally moving said forklift assembly relative to said front arm sections;
a pair of rear arm sections pivotally attached to said front arm sections such that one of said pair of rear arm sections is attached to one of said pair of front arm sections, and the other of said pair of rear arm sections is attached to the other of said pair of front arm sections;
a pair of arm hinge cylinders attached to said pair of front arm sections and to said pair of rear arm sections for pivotally moving said pair of front arm sections relative to said pair of rear arm sections; and
a pair of arm lift cylinders attached to said pair of rear arm sections and to said refuse collection vehicle for pivotally moving said pair of rear arm sections relative to said refuse collection vehicle;
said front loader arm structure being movable between a first position where a dumpster is engaged with the forklift assembly on a support surface at or near ground level and a second position where a dumpster is located over the storage area of the vehicle in a dump position;
movement of said pair of front and rear arm sections and said forklift assembly being controlled by said arm hinge cylinders, said arm lift cylinders, and said forklift cylinders.

2. The articulated front loader arm structure of claim 1 wherein said forklift cylinders, said arm hinge cylinders, and said arm lift cylinders each include a position sensor for monitoring the extension and retraction of each of said respective cylinders during articulation of the front loader arm structure.

3. The articulated front loader arm structure of claim 1 including a programmable logic controller for monitoring and controlling the extension and retraction of said pair of arm lift cylinders, said pair of arm hinge cylinders, and said forklift cylinders relative to each other as the front loader arm structure moves during both a container dump cycle and a container return cycle.

4. The articulated front loader arm structure of claim 3 wherein said programmed logic controller monitors the extension and retraction of each respective cylinder during movement of the front loader arm structure through the use of sensors associated with each respective cylinder, said program logic controller being programmed to control movement of the front loader arm structure such that the front loader arm structure and any dumpster engaged therewith will not hit or otherwise make contact with the cab compartment associated with the refuse collection vehicle during both its container dump cycle and its container return cycle.

5. The articulated front loader arm structure of claim 1 including an angular position sensor attached to a terminal end portion of at least one of said pair of front arm sections and to said forklift assembly for measuring the angular position of said forklift assembly relative to said pair of front arm sections.

6. The articulated front loader arm structure of claim 5 including a programmed logic controller coupled to said angular position sensor, said programmed logic controller storing in its memory the angular position of said forklift assembly relative to said pair of front arm sections after said forklift assembly engages a dumpster at or near ground level.

7. The articulated front loader arm structure of claim 1 wherein said front loader arm structure can be positioned and oriented for road travel over the storage area of the refuse collection vehicle at a height which is below 13 feet, 6 inches.

8. The articulated front loader arm structure of claim 1 wherein said forklift assembly includes a pair of forklift arms, one of said pair of forklift arms being attached to one of said pair of front arm sections, and the other of said pair of forklift arms being attached to the other of said pair of front arm sections.

9. The articulated front loader arm structure of claim 8 wherein one of said pair of forklift cylinders is attached to one of said pair of forklift arms and to one of said pair of front arm sections and the other of said pair of forklift cylinders is attached to the other of said pair of forklift arms and to the other of said pair of front arm sections.

10. The articulated front loader arm structure of claim 1 wherein one of said arm hinge cylinders is attached to one of said pair of front arm sections and to one of said pair of rear arm sections and the other of said pair of arm hinge cylinders is attached to the other of said pair of front arm sections and to the other of said pair of rear arm sections.

11. The articulated front loader arm structure of claim 1 wherein one of said pair of arm lift cylinders is attached to one of said pair of rear arm sections and to said refuse collection vehicle and the other of said pair of arm hinge cylinders is attached to the other of said pair of rear arm sections and to said refuse collection vehicle.

12. A system for controlling an articulated front loader arm structure for use with a refuse collection vehicle having a conventional cab compartment and a storage compartment, the articulated front loader arm structure being engagable with a dumpster for emptying the contents of the dumpster into the storage compartment of the refuse collection vehicle, the system comprising:
an articulated front loader arm structure comprising:
a forklift assembly including a pair of forklift arms for engaging a dumpster;
a pair of front arm sections pivotally attached to said forklift assembly such that one of said pair of forklift arms is attached to one of said pair of front arm sections, and the other of said pair of forklift arms is attached to the other of said pair of front arm sections;
a pair of forklift cylinders attached to said forklift assembly and to said pair of front arm sections such that one of said pair of forklift cylinders is attached to one of said pair of forklift arms and to one of said pair of front arm sections, and the other of said pair of forklift cylinders is attached to the other of said pair of forklift arms and to the other of said pair of front arm sections, and at least one position sensor associated with at least one of said pair of forklift cylinders for monitoring the extension and retraction of at least one of said pair of forklift cylinders during articulation of the articulated front loader arm structure;
a pair of rear arm sections pivotally attached to said pair of front arm sections such that one of said pair of rear arm sections is attached to one of said pair of front arm sections, and the other of said pair of rear arm sections is attached to the other of said pair of front arm sections;
a pair of arm hinge cylinders positioned and located between said pair of front arm sections and between said pair of rear arm sections such that one of said pair of arm hinge cylinders is positioned and located between one of said pair of front arm sections and one of said pair of rear arm sections, and the other of said pair of arm hinge cylinders is positioned and located between the other of said pair of front arm sections and the other of said pair of rear arm sections, and at least one position sensor associated with at least one of said pair of arm hinge cylinders for monitoring the extension and retraction of at least one of said pair of arm hinge cylinders during articulation of the articulated front loader arm structure;
a pair of arm lift cylinders positioned and located between said pair of rear arm sections and said refuse collection vehicle such that one of said pair of arm lift cylinders is positioned and located between one of said rear arm sections and between a first fixed point associated with said refuse collection vehicle, and the other of said pair of arm lift cylinders is positioned and located between the other of said pair of rear arm sections and between a second fixed point associated with said refuse collection vehicle, and at least one position sensor associated with at least one of said pair of arm lift cylinders for monitoring the extension and retraction of at least one of said arm lift cylinders during articulation of the articulated front loader arm structure; and
a programmable logic controller (PLC) coupled in communication with said respective pairs of arm hinge cylinders, said arm lift cylinders and said forklift cylinders, and respectively with the at least one position sensor associated with said pair of arm hinge cylinders, said pair of arm lift cylinders, and said pair of forklift cylinders for monitoring and controlling the extension and retraction of each of said respective cylinders during articulation of the articulated front loader arm structure, said PLC controlling movement of the articulated front loader arm structure between a first position where a dumpster is engaged with said pair of forklift arms on a support surface at or near ground level and a second position where a dumpster is positioned and located over the storage area of the refuse collection vehicle in a dump position.

13. The system of claim 12 including an angular position sensor positioned and located between the terminal end portion of at least one of said front arm sections and said forklift assembly for measuring the angular position of at least one of said forklift arms relative to at least one of said front arm sections, said angular position sensor being in communication with said PLC.

14. The system of claim 13 wherein said PLC includes memory for storing the measured angular position of at least one of said pair of forklift arms relative to at least one of said pair of front arm sections when a dumpster is initially engaged on a support surface at or near ground level.

15. The system of claim 12 wherein the PLC continuously monitors and adjusts the extension and retraction of the pair of arm hinge cylinders relative to the extension and retraction of the pair of arm lift cylinders to ensure that the position of the respective cylinders stay within a pre-determined range programmed into the PLC during articulation of the articulated front loader arm structure, both from its first position to its second position and from its second position to its first position.

16. The system of claim 15 wherein the PLC will either slow down the retraction of the arm hinge cylinders or slow down the retraction of the arm lift cylinders as needed so as to keep the position of the respective cylinders within the pre-determined range programmed into the PLC during movement of the articulated front loader arm structure, both from its first position to its second position and from its second position to its first position.

17. The system of claim 12 wherein at a predetermined location during movement of the articulated front loader arm structure from its first position to its second position, the PLC will send a signal to the pair of forklift cylinders to further extend so as to keep a dumpster somewhat level with the ground during at least a portion of its movement towards its second position.

18. The system of claim 12 wherein an operator can control movement of the articulated front loader arm structure and can activate the PLC through any one of a control panel, a joy stick or other control mechanism located in the cab compartment.

19. The system of claim 12 wherein when said pair of arm lift cylinders and said pair of arm hinge cylinders reach full retraction, the articulated front loader arm structure will be located at its second position and a dumpster engaged with said forklift assembly will be located above the refuse collection vehicle and over the storage compartment.

20. The system of claim 19 wherein when the front loader arm structure reaches its second position, the PLC will send a signal to the pair of forklift cylinders to retract the forklift cylinders thereby rotating a dumpster located above the storage compartment so as to dump the contents of a dumpster into the storage compartment.

21. The system of claim 20 wherein after a dumpster is emptied, the PLC will send a signal to said forklift cylinders to initially extend said forklift cylinders a pre-determined amount to partially rotate a dumpster away from its dump position, and the PLC will also send a signal to partially extend the arm hinge cylinders a pre-determined amount while leaving the arm lift cylinders retracted.

22. The system of claim 21 wherein the initial extension of said forklift cylinders to a pre-determined amount is such that the angular orientation between at least one of said pair of forklift arms and the terminal end portion of at least one of said front arm sections will be the same as the angular orientation of at least one of said pair of forklift arms and the terminal end portion of at least one of said front arm sections when said fork assembly initially engaged a dumpster on a support surface at or near ground level.

23. The system of claim 21 wherein once said arm hinge cylinders extend a pre-determined amount during its extension after a dumpster has been emptied, the PLC will send a signal to said arm hinge cylinders to continue to extend while likewise sending a signal to said arm lift cylinders to begin their extension thereby starting movement of the articulated front loader arm structure from its second position to its first position.

24. The system of claim 12 wherein the articulated front loader arm structure can be positioned and oriented for road travel on top of the refuse collection vehicle and over the storage area at a height which is under 13 feet, 6 inches.

25. The system of claim 12 wherein communication between the PLC and the at least one position sensor associated with each of said pair of forklift cylinders, said pair of arm hinge cylinders and said pair of arm lift cylinders is a wireless communication.

26. The system of claim 12 wherein said pair of arm hinge cylinders reach full extension prior to said pair of arm lift cylinders reaching their full extension when the articulated front loader arm structure is moving from its second position to its first position.

27. The system of claim 12 wherein after the articulated front loader arm structure has completed its movement from its second position to its first position, the PLC is activated to signal the and lift cylinders, the arm hinge cylinders, and the forklift cylinders all to retract at a pre-programmed rate to a pre-determined position.

28. The system of claim 27 wherein said pre-determined position is a road travel stowed position on top of the refuse collection vehicle and over the storage compartment at a height which is under 13 feet, 6 inches.

29. The system of claim 28 wherein when the articulated front loader arm structure is in its road travel stowed position, all cylinders are fully retracted, and said pair of rear arm sections are positioned and located at the side of the storage compartment and below the top edge portion thereof.

30. The system of claim 12 including a user interface for enabling an operator to initiate movement of the front loader arm structure between its first position and its second position, and between its second position and its first position.

31. The system of claim 12 wherein communication between the PLC and the respective pairs of arm hinge cylinders, said arm lift cylinders and said forklift cylinders is a wireless communication.
